(19) United States
(12) Patent Application Publication
(10) Pub. No.: US 2015/0300914 A1
(43) Pub. Date: Oct. 22, 2015

(54) BACKLIGHT UNIT TESTING JIG, METHOD FOR SIMULATING STATE OF BACKLIGHT UNIT AND APPARATUS FOR TESTING RELIABILITY

(71) Applicants: BOE TECHNOLOGY GROUP CO., LTD., Beijing (CN); BEIJING BOE CHATANI ELECTRONICS CO., LTD., Beijing (CN)

(72) Inventors: Qiaowei CHONG, Beijing (CN); Dongsheng YANG, Beijing (CN)

(21) Appl. No.: 14/436,278

(22) PCT Filed: Aug. 21, 2014
(86) PCT No.: PCT/CN2014/084913

§ 371 Date: Apr. 16, 2015

(30) Foreign Application Priority Data
Dec. 31, 2013 (CN) 201310752912.X

(51) Int. Cl. G01M 11/08

(52) U.S. Cl. CPC G01M 11/08

(57) ABSTRACT

A backlight unit testing jig, a method for simulating a state of a backlight unit and an apparatus for testing reliability are provided, the testing jig comprises a jig base (6) and four jig side frames (7, 8, 9), the four jig side frames (7, 8, 9) are provided on the jig base (6) and sequentially interconnected with each other to form a cavity structure. With this testing jig, it's possible to simulate a state of a material in a backlight unit, thus shorten the development cycle, reduce development risk, and thereby improve development efficiency.

### TECHNICAL FIELD

At least one embodiment of the present disclosure relates to a backlight unit testing jig, a method for simulating a state of a backlight unit and an apparatus for testing reliability.

### BACKGROUND

For the present, in panel display technologies, a liquid crystal display (LCD) per se does not emit light, and the liquid crystal display displays a figure or character by modulating the light, so a backlight unit is necessary for a transmission LCD.

The backlight unit (BLU) is a kind of illuminant module disposed at the back of a liquid crystal display, and the illuminant effect of the backlight unit can directly influence the visual effect of a liquid crystal display module.

As shown in FIG. 1, a backlight unit mainly comprises a light source (not shown in FIG. 1), a light guide plate 3, an optical film 2 and a plurality of structures. The structures comprise, for example, a backlight unit frame 4, a shading double-faced adhesive tape 5 and the like. Actually, the optical film 2 and the light guide plate 3 are arranged within a closed environment formed by bonding the liquid crystal screen 1 and the backlight unit frame 4 through the double-faced adhesive tape. During the processes of developing the backlight unit and testing prophase technologies, the reliability result of a material is usually one of the parts difficult to be tested. For the present, situations are usually that a single product test of a material is performed during the prophase of the development or the testing of the entire backlight unit is performed during the middle period of the development.

### SUMMARY

At least one embodiment of the present disclosure provides a backlight unit testing jig, a method for simulating a state of a backlight unit and an apparatus for testing reliability, and with this testing jig, it's possible to simulate the state of a material in the backlight unit, thus shorten the development cycle, reduce the development risk, and thereby improve the development efficiency.

At least one embodiment of the present disclosure provides a backlight unit testing jig, which comprises a jig base and four jig side frames, and the four jig side frames are provided on the jig base and sequentially interconnected with each other to form a cavity structure.

At least one embodiment of the present disclosure provides a method for simulating a state of a backlight unit, comprising: providing a jig base and four jig side frames, placing the four jig side frames on the jig base and sequentially interconnecting the four jig side frames to form a cavity structure; and placing a material, which is to be tested, of the backlight unit, in the cavity structure for performing an experiment.

At least one embodiment of the present disclosure provides an apparatus for testing reliability comprising the above-mentioned backlight unit testing jig.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a sectional structural view of a backlight unit;

FIG. 2 is a first structural view of a backlight unit testing jig of an embodiment of present disclosure;

FIG. 3 is a second structural view of a backlight unit testing jig of an embodiment of present disclosure; and

FIG. 4 is a sectional structural view of a backlight unit testing jig of an embodiment of present disclosure.

### REFERENCE NUMERALS

1: liquid crystal screen; 2: optical film; 3: light guide plate; 4: backlight unit frame; 5: shading double-faced adhesive tape; 6: jig base; 7: fixed jig side frame; 8: length adjusting side frame; 9: width adjusting side frame; 10: fixing screw; 11: length calibration groove; 12: width calibration groove; 13: material to be tested; 14: transparent lid.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

The inventor of the present application noted that, when performing a single product test for a material of the backlight unit, there is always no jigs available or it's impossible to simulate the state when the material is located within the backlight unit, thus the test result is influenced; and performing the test in the middle period of the development can influence development time.

At least one embodiment of the present disclosure provides a backlight unit testing jig, a method for simulating a state of a backlight unit and an apparatus for testing reliability, and with this testing jig, it's possible to simulate the state of a material in a backlight unit, thus shorten the development cycle, reduce the development risk, and thereby improve the development efficiency. Due to the adoption of a structural design of adjusting side frame, the testing jig provided by at least one embodiment of the present disclosure can be applied in a broad testing dimensional range, and can be freely regulated according to the designed sizes, one jig can be used to test the products of various dimensions, and thus this greatly reduces the cost.

As shown in FIG. 1, a backlight unit mainly comprises a light source (not shown in the Figure), a light guide plate 3, an optical film 2 and a plurality of structures. The structures comprise, for example, a backlight unit frame 4, a shading double-faced adhesive tape 5 and the like. The optical film 2 comprises a diffusing sheet, a prism sheet etc.

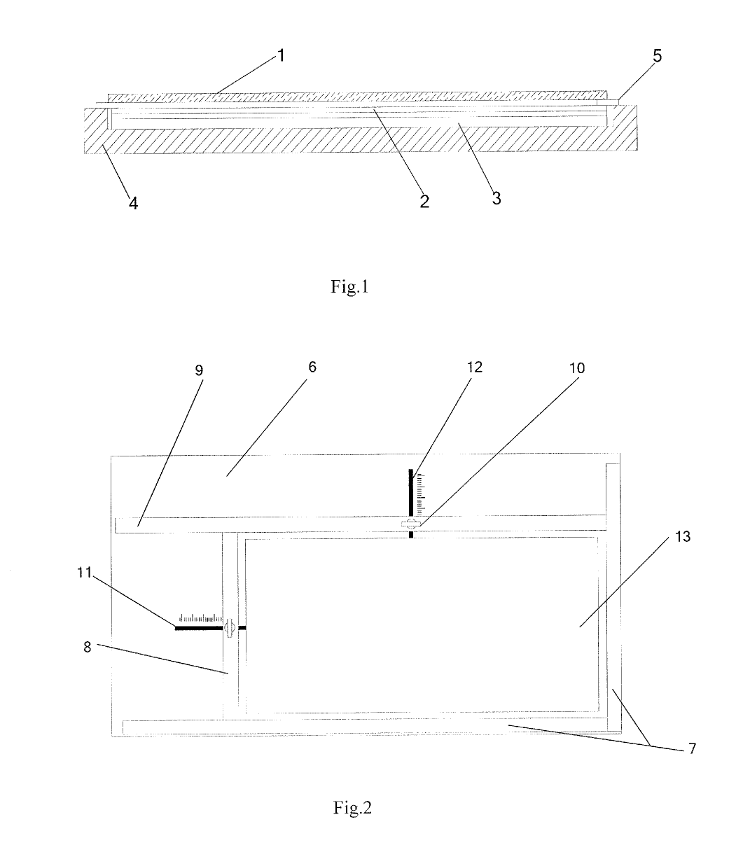

As shown in FIG. 2, at least one embodiment of the present disclosure provides a backlight unit testing jig comprising a jig base 6 and four jig side frames. In one example, the four jig side frames are provided on the jig base, are perpendicular to each other and sequentially interconnected with each other to form a cavity structure. After the completion of assembling the cavity structure of the testing jig, a material, which is to be tested, of a backlight unit can be placed within the cavity structure for performing an experiment. By using such a testing jig, its possible to complete the test for the material of the backlight unit more quickly and efficiently, for example, the test for the reliability of the light guide plate and the optical film, the optical test for the backlight unit, and so on; and by using such a testing jig, it's possible to greatly shorten the development cycle, and reduce the development risk. To be noted, the jig side frames can be all provided on the top surface of the jig base 6, and can also be provided at other positions on the jig base 6 or on other structures, for example, in the embodiments mentioned hereinafter, the fixed jig side frame can also be provided at a side of an edge of the jig base 6. No limitations are imposed thereto.

In the backlight unit testing jig provided by at least one embodiment of the present disclosure, at least one of the four jig side frames is a position adjusting side frame configured to be movable in a predetermined direction to determine a position.

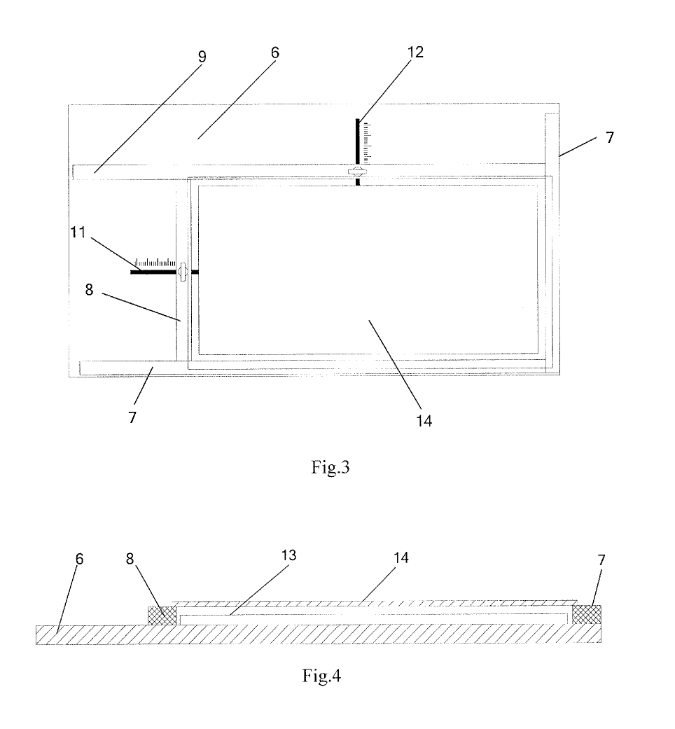

As shown in FIGS. 2 and 3, in one example, two adjacent jig side frames of the four jig side frames are fixed jig side frames 7 and fixedly connected to the jig base 6; and the other two jig side frames respectively act as a length adjusting side frame 8 and a width adjusting side frame 9, the length adjusting side frame 8 is configured to be movable in a length direction of the cavity structure to determine a position and the width adjusting side frame 9 is configured to be movable in a width direction of the cavity structure to determine a position. The length of the length adjusting side frame 8 can be designed according to the outer width of the components to be tested (for example, backlight units of different types); and the length adjusting side frame can move leftwards or rightwards along the length direction of the cavity structure, and thereby the length of the cavity structure can be controlled. In one example, the width adjusting side frame 9 can have a fixed length and can be vertically movable in the width direction of the cavity structure, so as to control the width of the cavity structure. Of course, embodiments of present disclosure are not limited thereto. For example, a width adjusting side frame of a different length can also be provided as required. In this way, with the cavity structure comprising the above-mentioned four jig side frames, a reliability test can be performed upon the materials to be tested in different dimensional ranges, and this greatly reduces the cost of a reliability test. In various examples, the length adjusting side frame 8 and the width adjusting side frame 9 can be selectively used according to practical situations.

The backlight unit testing jig provided by at least one embodiment of the present disclosure further comprises at least one calibration positioning mechanism, and the position adjusting side frame is configured to be movable in the calibration variation direction of the calibration positioning mechanism to determine a position. The calibration positioning mechanism acts for precisely positioning, so as to ensure the dimension accuracy of the cavity structure. The calibration positioning mechanism can, for example, use a calibration groove structure on which the position adjusting side frame is provided.

As shown in FIGS. 2 and 3, in one example, the top surface of the jig base is provided with a length calibration groove 11 and a width calibration groove 12; the length adjusting side frame 8 is disposed on the length calibration groove 11, and its position can be regulated along the length calibration groove 12; and the width adjusting side frame 9 is disposed on the width calibration groove 12, and its position can be regulated along the width calibration groove 12. The length calibration groove 11 and the width calibration groove 12 act for precisely positioning, so as to ensure the dimension accuracy of the cavity structure. When the length adjusting side frame 8 and the width adjusting side frame 9 are regulated to predetermined positions respectively, the length adjusting side frame 8 and the width adjusting side frame 9 can be fixed correspondingly to the length calibration groove 11 and the width calibration groove 12 in the jig base by means of fixing screws, in such a way that the dimension accuracy of the cavity structure of the jig and the stability of the testing jig are guaranteed. The dimension of the cavity structure of the jig can be determined according to the design parameters of a product. In various examples, the length calibration groove 11 and the width calibration groove 12 can be selectively used according to practical situations. The length calibration groove 11 and the width calibration groove 12 each can have groove calibrations divided, for example, taking 0.1 mm as the unit, and can be regulated using a magnifying glass in the process of setting up the jig. The reason why 0.1 mm is selected as the groove scale accuracy is that, considering the situation of machining accuracy of the jig, a scale accuracy of 0.1 mm is relatively easier to be assured presently, and further, the scale accuracy of 0.1 mm is able to satisfy the request for utilization; and improving the scale accuracy can cause an even more complicated setting up.

In at least one example, each of the jig side frames has a width not smaller than 5 mm. In various examples, for the jig side frame, when an optical film is to be tested, the height of the frame is, for example, from 0.6 mm to 1 mm; and when a light guide plate is to be tested, the height of the frame is, for example, from 0.8 mm to 1.2 mm. Usually, the thickness of the film for a backlight unit of medium or small size is from 0.06 mm to 0.15 mm, and 4 layers of film can have a thickness from 0.25 mm to 0.6 mm or so when being stacked, so the height of the frame used for testing an optical film should ensure to accommodate 4 layers of film, and ensure a minor gap so as to simulate actual service condition. Therefore, the range for the height of the frame is from 0.6 mm to 1.0 mm. Moreover, the thickness of a light guide plate is usually from 0.5 mm to 1.0 mm, so the height of the frame used for testing an optical film should ensure to accommodate a light guide plate and also ensure a minor gap so as to simulate actual service condition. The height of the frame used for testing a light guide plate is from 0.8 mm to 1.2 mm.

The materials of the jig base and the jig side frame can be preferably one of a glass material, a composite material and a plastic material, which have a lower expansion coefficient, or the combination thereof. In order to simulate the actual relatively sealed environment within the cavity better, the material for the jig side frames can chose such a material of polycarbonate (PC) +30% glass fiber (GF), that is, a kind of modified material of polycarbonate added with 30% glass fiber, such a material has a steady relative linear expansion coefficient so as to approximate the actual application environment. By precisely defining the dimension of the cavity structure of the testing jig, and by excluding the factors such as thermal expansion and the like, other than the sample to be tested, so as to accurately test the variation of the sample to be tested, thus a more accurate test can be achieved.

As shown in FIGS. 2, 3 and 4, a reliability testing is performed upon a material of the backlight unit, firstly, the dimension of the material 13 to be tested is measured, and then a custom-built length adjusting side frame 9 is selected according to the dimension of the material 13 to be tested, the length adjusting side frame 9 and a width adjusting side frame 10 of the jig are regulated to predetermined positions respectively, in such a way that the dimension of the jig is greater than the dimension of the material to be tested so as to accommodate the material to be tested. The material to be tested 13, the dimension of which is tested, is placed onto the jig base 6.

In one example, in order that the test can be performed in an enclosed environment approximating to the state of the backlight unit, as shown in FIGS. 3 and 4, a transparent lid 14, which is made of plastic or glass or other materials, is placed onto the top surface of the cavity structure of the testing jig and hermetically fixed, so that the inside of the cavity structure forms a relatively enclosed cavity. The transparent lid 14 can select a material similar to that of the jig side frames, to ensure a better contact therebetween and maintain an identical linear expansion coefficient. For example, the transparent lid 14 can adopt a transparent plastic, and no limitations are imposed thereto. Such a sealed cavity structure aims to simulate the actual assembled structure of a backlight unit. As shown in FIG. 1, the optical film and light guide plate in a backlight unit of middle or small size are actually disposed within a closed environment formed by bonding a liquid crystal screen and a backlight unit frame through a double-faced adhesive tape, therefore, the jig according to the embodiments is intended to simulate such an environment. The sealing manner can be achieved by using a sealing ring (not shown in the drawings).The cavity structure is provided with a sealing structure at a position where the jig side frames contact with the jig base, and the cavity structure is also provided with a sealing structure at a position where the jig side frames contact with the illustrated transparent lid, in such a way that the sealability within the cavity structure can be ensured. The sealing structures can be made of nonmetallic materials of good sealability, such as, rubber. Usually, reliability issues tend to occur with respect to backlight units of middle or small dimensions, so the dimensions applied to the width and height of the jig side frame are basically middle and small dimensions, in this way, it's possible to ensure the collimation. The transparent lid is fixed, for example, by means of a fixing screw on its top surface, and cooperates with a sealing structure (of a kind of materials usually having a great friction coefficient to facilitate the fixing) attached to the bottom surfaces of the jig side frames, so as to reach the fixing effect. After the integral assembly, the entirety of the testing jig can be placed into the apparatus for testing reliability for testing.

At least one embodiment of the present disclosure provides a method for simulating a state of a backlight unit, comprising: providing a jig base and four jig side frames, placing the four jig side frames on the jig base and sequentially interconnecting the four jig side frames to form a cavity structure; and placing a material, which is to be tested, of the backlight unit, in the cavity structure for performing an experiment. By forming the cavity structure, this simulation method can simulate a state of a material in a backlight unit, thus by placing the material, which is to be tested, of the backlight unit, in the cavity structure to perform an experiment, ifs possible to shorten development cycle, reduce development risk, and thereby improve development efficiency.

In one example, placing the four jig side frames on the jig base comprises that: at least one of the four jig side frames is provided as a position adjusting side frame which is movable in a predetermined direction to determine a position. Due to the adoption of a structural design of the adjusting side frame, the simulation method can be applied to a broad testing dimensional range, and this greatly reduces the cost.

In one example, the material of the jig side frames is polycarbonate +30% glass fiber. Such a material has a steady relative linear expansion coefficient, which is even more approximate to the practical application environment.

In one example, each of the jig side frames has a width not smaller than 5 mm. In at least one embodiment of the present disclosure, each of the jig side frames has a height in the range of 0.6-1 mm or 0.8-1.2 mm. In this way, the width and height of the jig side frames are more applicable to materials to be tested in medium and small size.

In one example, the method for simulating a state of a backlight unit further comprises: placing a transparent lid on the top surface of the cavity structure and hermetically securing the transparent lid. In this way, the test can be made to be performed in an enclosed environment even more approximating the state of the backlight unit.

At least one embodiment of the present disclosure also provides an apparatus for testing reliability, and the apparatus comprises the above-mentioned backlight unit testing jig. The testing jig can be mounted within the apparatus for testing reliability, and can also be interfaced with the apparatus for testing reliability.

What are described above are merely the preferred embodiments of the present disclosure, and not limitative to the scope of the disclosure; and any modifications, equivalents, improvements etc. made within the spirit and principle of the present disclosure belong to the scope of the present disclosure.

The present application claims the priority of the Chinese Patent Application No. 201310752912.X, filed on Dec. 31, 2013, which is hereby entirely incorporated by reference as a part of the present application.

1. A backlight unit testing jig, comprising a jig base and four jig side frames, wherein the four jig side frames are provided on the jig base and sequentially interconnected with each other, to form a cavity structure.

2. The backlight unit testing jig according to claim 1, wherein at least one of the four jig side frames comprises a position adjusting side frame configured to be movable in a predetermined direction to determine a position.

3. The backlight unit testing jig according to claim 2, further comprising: at least one calibration positioning mechanism, wherein the position adjusting side frame is configured to be movable in a calibration variation direction of the calibration positioning mechanism to determine the position.

4. The backlight unit testing jig according to claim 1, wherein two adjacent jig side frames of the four jig side frames are respectively configured to be a fixed jig side frame and fixedly connected to the jig base; and the other two jig side frames respectively act as a length adjusting side frame and a width adjusting side frame, the length adjusting side frame is configured to be movable in a length direction of the cavity structure to determine a position, and the width adjusting side frame is configured to be movable in a width direction of the cavity structure to determine a position.

5. The backlight unit testing jig according to claim 4, further comprising: a length calibration positioning mechanism and/or a width calibration positioning mechanism, wherein the length adjusting side frame is disposed on the length calibration positioning mechanism, and the width adjusting side frame is disposed on the width calibration positioning mechanism.

6. The backlight unit testing jig according to claim 5, wherein at least one of the length calibration positioning mechanism and the width calibration positioning mechanism comprises a groove structure.

7. The backlight unit testing jig according to claim 5, wherein a scale division of the length calibration positioning mechanism and/or the width calibration positioning mechanism is 0.1 mm.

8. The backlight unit testing jig according to claim 1, wherein each of the jig side frames has a width not smaller than 5 mm.

9. The backlight unit testing jig according to claim 1, wherein each of the jig side frames has a height ranging from 0.6 mm to 1 mm or from 0.8 mm to 1.2 mm.

10. The backlight unit testing jig according to claim 1, wherein the jig base and the jig side frames are made of at least one material selected from the group consisting of glass material, composite material and plastic material.

11. The backlight unit testing jig according to claim 1, wherein a material of the jig side frames comprises polycarbonate with 30% glass fiber in weight.

12. The backlight unit testing jig according to claim 1, wherein a top surface of the cavity structure is configured to be sealed by and fixed with a transparent lid.

13. The backlight unit testing jig according to claim 12, wherein the cavity structure is provided with a sealing structure at a position where the jig side frames contact the jig base, and the cavity structure is configured to be provided with a sealing structure at a position where the jig side frames contact the transparent lid.

14. A method for simulating a state of a backlight unit, comprising:
providing a jig base and four jig side frames, placing the four jig side frames on the jig base and sequentially interconnecting the four jig side frames to form a cavity structure; and
placing a material, which is to be tested, of the backlight unit, in the cavity structure for performing an experiment.

15. The method for simulating the state of the backlight unit according to claim 14, wherein placing the four jig side frames on the jig base comprises;
allowing at least one of the four jig side frames to act as a position adjusting side frame which is movable in a predetermined direction to determine a position.

16. The method for simulating the state of the backlight unit according to claim 14, wherein a material of the jig side frames comprises polycarbonate with 30% glass fiber in weight.

17. The method for simulating the state of the backlight unit according to claim 14, wherein each of the jig side frames has a width not smaller than 5 mm.

18. The method for simulating the state of the backlight unit according to claim 14, wherein each of the jig side frames has a height ranging from 0.6 mm to 1 mm or from 0.8 mm to 1.2 mm.

19. The method for simulating the state of the backlight unit according to claim 14, further comprising: placing a transparent lid on a top surface of the cavity structure, so that the top surface of the cavity structure is sealed by and fixed with the transparent lid.

20. An apparatus for testing reliability, comprising a backlight unit testing jig wherein the backlight unit testing jig comprises a jig base and four jig side frames, and the four jig side frames are provided on the jig base and sequentially interconnected with each other, to form a cavity structure.
